(19) United States
(12) Patent Application Publication
(10) Pub. No.: US 2003/0110766 A1
(43) Pub. Date: Jun. 19, 2003

(54) Hydraulic system with improved efficiency

(76) Inventors: Willibald G. Berlinger, Peoria, IL (US); Francis J. Raab, (US)

Correspondence Address: Todd T. Taylor, Taylor & Aust, P.C., 142 S. Main Street, P.O. Box 560, Avilla, IN, 46710, US

(21) Appl. No.: 10/022,004

(22) Filed: Dec. 13, 2001

(51) Int. Cl. F16D 31/02

(52) U.S. Cl. 60/419

(57) ABSTRACT

A hydraulic system, particularly suitable for use in a work machine, is provided with a hydraulic pressure source. A hydraulic transformer has an inlet and an outlet, with the inlet being coupled with the pressure source. A bypass valve operatively couples at least one hydraulic motor selectively either with the pressure source or the hydraulic transformer outlet, depending upon an operating characteristic associated with at least one hydraulic motor. Each hydraulic motor is operated at a high efficiency by providing the inlet hydraulic fluid at an amplified or non-amplified state.

### TECHNICAL FIELD

The present invention relates to hydraulic systems, and, more particularly, to hydraulic systems utilizing a hydraulic transformer and hydraulic motor.

### BACKGROUND

Hydraulic systems typically receive high pressure hydraulic fluid from a pressure source and convert the hydraulic input energy into mechanical output energy. It is known to provide a hydraulic system with a hydraulic transformer which amplifies the hydraulic pressure received at the inlet thereof. The hydraulic transformer may provide higher pressure hydraulic fluid to a downstream load such as a hydraulic motor, hydrostatic transmission, hydraulic cylinder, etc. The hydraulic transformer includes an inlet and an outlet which are continuously fluidly coupled between the high pressure source of hydraulic fluid and the downstream load. The amplified pressure is thus always provided to the downstream load, regardless of operating conditions associated with the load. An example of such a hydraulic transformer is disclosed in WO93/10344 (Achten, et al.).

The present invention is directed to overcoming one or more of the problems as set forth above.

### SUMMARY OF THE INVENTION

In one aspect of the invention, a hydraulic system is provided with a hydraulic pressure source. A hydraulic transformer has an inlet and an outlet, with the inlet being coupled with the pressure source. A bypass valve operatively couples at least one hydraulic motor selectively either with the pressure source or the hydraulic transformer outlet, depending upon an operating characteristic associated with at least one hydraulic motor,

In another aspect of the invention, a hydraulic system is provided with a hydraulic pressure source. A hydraulic transformer has an inlet and an outlet with the inlet being coupled with the pressure source. A plurality of hydraulic motors are each fluidly coupled in a parallel manner with the hydraulic transformer outlet and/or pressure source. At least two of the hydraulic motors are configured with different operating ranges.

### BRIEF DESCRIPTION OF THE DRAWINGS

FIG. 1 is a schematic illustration of an embodiment of a hydraulic system of the present invention incorporated within a work machine;

FIG. 2 is a schematic illustration of another embodiment of a hydraulic system of the present invention; and

FIG. 3 is a schematic illustration of yet another embodiment of a hydraulic system of the present invention.

### DETAILED DESCRIPTION

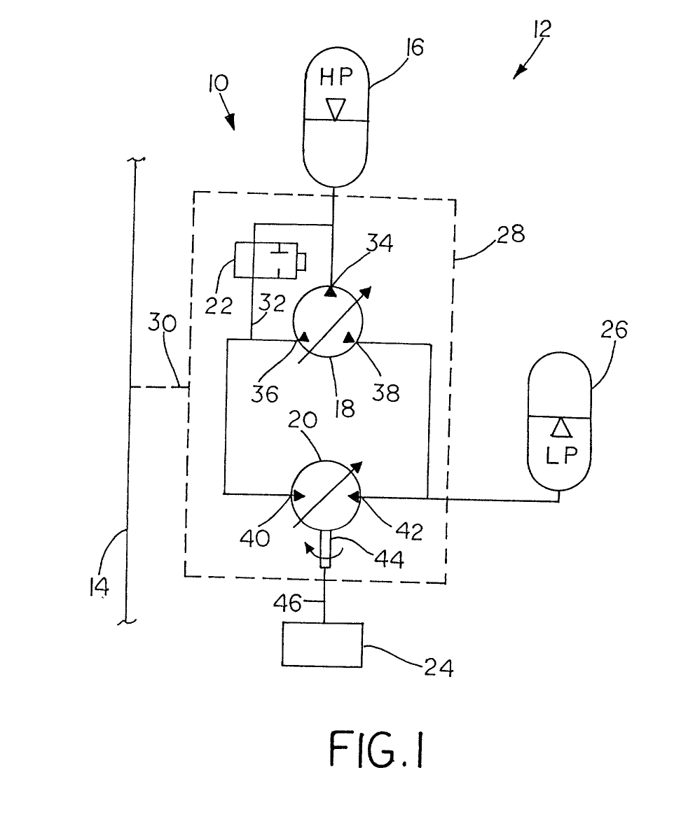

Referring now to the drawings, and more particularly to FIG. 1, there is shown an embodiment of a hydraulic system 10 of the present invention. In the embodiment shown, hydraulic system 10 is part of a work machine 12 such as a tractor, backhoe, motor vehicle, etc. Work machine 12 includes a frame 14 which carries hydraulic system 10.

Hydraulic system 10 generally includes a hydraulic pressure source in the form of a high pressure accumulator 16, a hydraulic transformer 18, a hydraulic motor 20, a bypass valve 22, a hydraulic load 24 and a low pressure accumulator 26. High pressure accumulator 16 is provided with high pressure hydraulic fluid and directly or indirectly drives hydraulic motor 20 using the high pressure hydraulic fluid.

Hydraulic transformer 18, hydraulic motor 20 and bypass valve 22 are each positioned within a common housing 28. Housing 28 is carried by frame 14, as indicated by line 30.

Bypass valve 22 may be actuated either hydraulically or electrically, depending upon the application, to shunt high pressure hydraulic fluid around hydraulic transformer 18 via line 32. Bypass valve 22, in the embodiment shown, is configured as a normally open valve so that the hydraulic fluid is only shunted around hydraulic transformer 18 when the pressure of the hydraulic fluid flowing from high pressure accumulator 16 is sufficient to drive hydraulic motor 20 at a given operating range.

Hydraulic transformer 18 includes an inlet 34, outlet 36 and a low pressure inlet 38. Inlet 34 is directly fluidly coupled with high pressure accumulator 16; outlet 36 is directly fluidly coupled with hydraulic motor 20; and low pressure outlet 38 is fluidly coupled with low pressure accumulator 26. Hydraulic transformer 18 is adjustable so that high pressure hydraulic fluid received at inlet 34 is selectively coupled with outlet 36 to control the amount of pressure amplification flowing therethrough. For example, hydraulic transformer 18 may include a port plate or port barrel therein (not shown), in known manner, to control the pressure amplification of the hydraulic fluid flowing from outlet 36, relative to the pressure at inlet 34.

Hydraulic motor 20 includes an inlet 40 fluidly coupled with each of bypass valve 22 and hydraulic transformer 18; and an outlet 42 which is fluidly coupled with low pressure accumulator 26. Hydraulic motor 20 includes an output shaft 44 which is coupled with hydraulic load 24, as indicated schematically by line 46. Hydraulic motor 20 is selectively adjustable so as to provide output shaft 44 with a desired rotational speed and/or torque depending upon operating conditions.

Hydraulic load 24 may be of any selected type such as a wheel, gear box, etc.

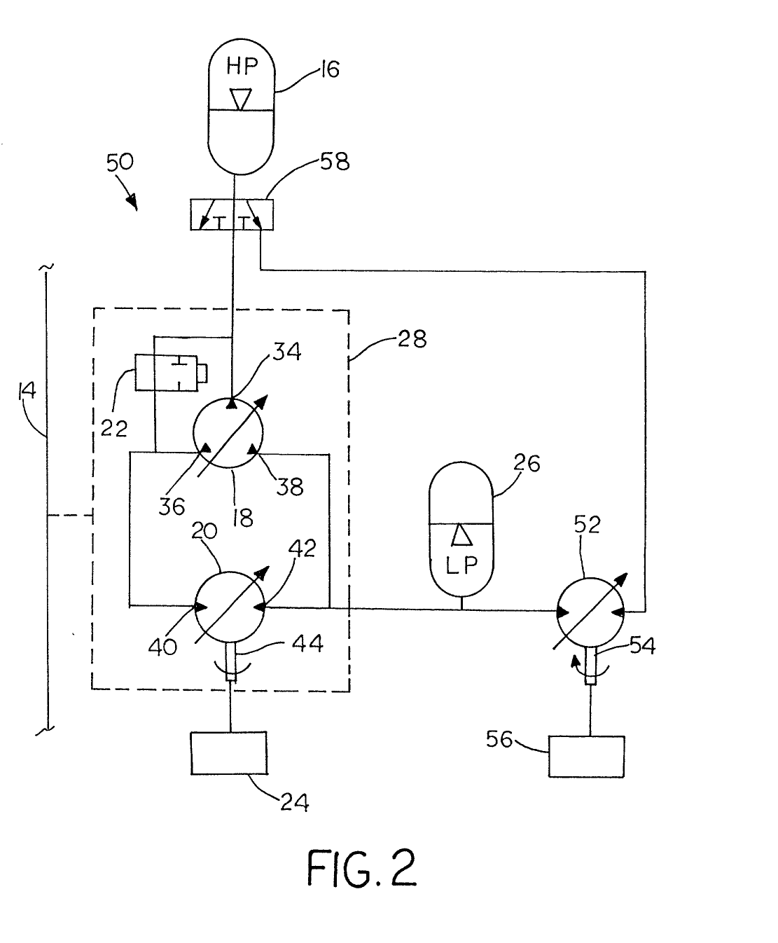

Referring now to FIG. 2, there is shown another embodiment of a hydraulic system 50 of the present invention which likewise may be carried by a frame 14 of a work machine such as a motor vehicle, etc. Hydraulic system 50 includes a high pressure accumulator 16, hydraulic transformer 18, hydraulic motor 20, bypass valve 22, hydraulic load 24, low pressure accumulator 26 and housing 28, similar to the embodiment of hydraulic system 10 shown in FIG. 1. Hydraulic system 50 differs from hydraulic system 10 in that a second hydraulic motor 52 is provided which is coupled in a parallel manner with hydraulic motor 20, relative to high pressure accumulator 16. Hydraulic motor 52 includes an output shaft 54 which is coupled with load 56. In the embodiment shown in FIG. 2, hydraulic load 24 and hydraulic load 56 are shown as separate loads. However, it will be understood that hydraulic load 24 and hydraulic load 56 may in fact be a common hydraulic load which is selectively driven by hydraulic motor 20 and/or hydraulic motor 52.

An electrically or mechanically operated switch 58 is coupled in parallel with each of hydraulic motor 20 and hydraulic motor 52. Switch 58 is selectively actuatable to fluidly couple high pressure accumulator 16 with hydraulic motor 20 and/or hydraulic motor 52.

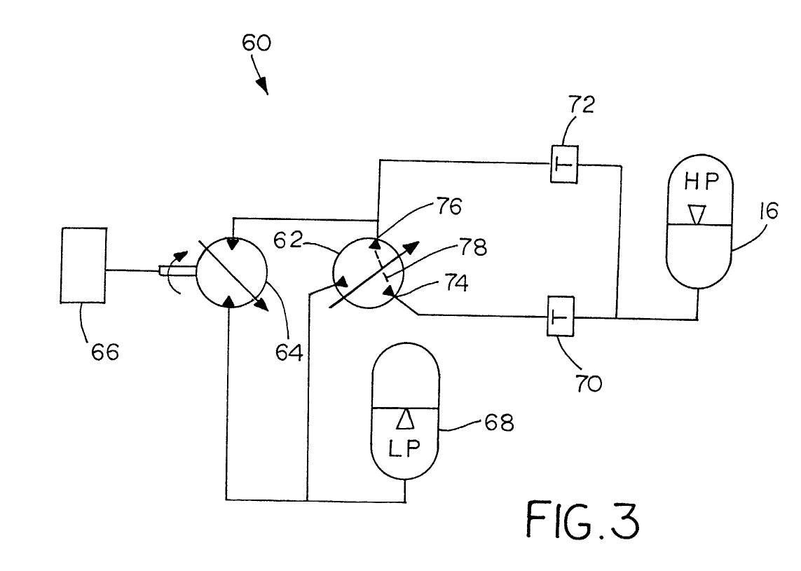

Referring now to FIG. 3, yet another embodiment of a hydraulic system 60 of the present invention is shown. Hydraulic system 60 includes a hydraulic transformer 62, a hydraulic motor 64, hydraulic load 66 and low pressure accumulator 68, similar to the embodiment of hydraulic system 10 shown in FIG. 1. However, hydraulic system 60 does not include a bypass valve 22 as shown in the embodiments of hydraulic systems 10 and 50 in FIGS. 1 and 2. Rather, hydraulic system 60 includes a pair of independently operable valves 70 and 72 which are respectively coupled with inlet 74 and outlet 76 of hydraulic transformer 62. Opening valve 72 and closing valve 70 completely bypasses hydraulic transformer 62. Moreover, hydraulic transformer 62 is provided with an internal bypass port 78 which, depending upon the position of a port plate or port barrel (not shown) within hydraulic transformer 62, bypasses a variable amount of hydraulic fluid directly from inlet 74 to outlet 76 without amplification. Thus, under some operating conditions, hydraulic motor 64 may be directly coupled with high pressure accumulator 16 by opening valve 72 and closing valve 70. Under other operating conditions, valve 72 may be closed and valve 70 may be opened so that the pressure of the hydraulic fluid from high pressure accumulator 16 may be amplified using hydraulic transformer 62. The amount of pressure amplification may be varied by bypassing a varying amount of hydraulic fluid from inlet 74 to outlet 76 through bypass port 78 defining a bypass valve through hydraulic transformer 62.

### INDUSTRIAL APPLICABILITY

Referring again to FIG. 1, the method of operation of hydraulic system 10 will be described in more detail. Bypass valve 22 couples hydraulic motor 20 selectively either with high pressure accumulator 16 or hydraulic transformer outlet 36, depending upon an operating characteristic associated with hydraulic motor 20. More particularly, bypass valve 22 operatively couples hydraulic motor 20 with high pressure accumulator 16 and/or hydraulic transformer 18, depending upon an output speed and/or output torque associated with output shaft 44 of hydraulic motor 20. When coupled directly with high pressure accumulator 16, hydraulic motor 20 operates within an operating range corresponding to the pressure received at inlet 40. Conversely, when coupled directly with outlet 36 of hydraulic transformer 18, hydraulic motor 20 operates within an operating range corresponding to the amplified pressure received at inlet 40.

Hydraulic system 10 allows hydraulic motor 20 to operate within two different operating ranges, depending upon whether the pressure received at inlet 40 is a non-amplified pressure directly from high pressure accumulator 16 or an amplified pressure from hydraulic transformer 18. It is thus possible to utilize a smaller motor 20 over a wider range of operating conditions by providing non-amplified or amplified hydraulic fluid to the inlet thereof

Referring now to FIG. 2, the method of operation of hydraulic system 50 will be described in greater detail. The components within housing 28 are the same as those shown in FIG. 1 and thus will not be described in further detail. Switch 58 is actuated to provide hydraulic fluid from high pressure accumulator 16 to hydraulic motor 20 and/or hydraulic motor 52. Hydraulic motor 52 is a smaller motor when compared with hydraulic motor 20. Under high speed, lower torque conditions, the smaller hydraulic motor 52 operates at a higher efficiency and thus is directly coupled with high pressure accumulator 16. As operating conditions change, the speed requirements may decrease and the torque requirements may increase. When hydraulic motor 52 is no longer operating within an efficient range, switch 58 is actuated to provide hydraulic fluid from high pressure 16 to hydraulic motor 20. Under some operating conditions, bypass valve 22 is actuated to fluidly couple hydraulic motor 20 directly with high pressure accumulator 16. Hydraulic motor 20 operates at a higher efficiency when at lower speed, higher torque requirements with respect to hydraulic motor 52. If the speed requirement further decreases and the torque increases, valve 22 is actuated to operatively couple hydraulic motor 20 with hydraulic transformer 18.

With the embodiment of hydraulic system 50 shown in FIG. 2, hydraulic motors 20 and 52 are selectively utilized to operate at higher efficiencies. Hydraulic motor 52 is utilized when operating under high speed, low torque requirements. Hydraulic motor 20 is operated with a non-amplified or amplified inlet pressure, depending upon speed and torque requirements to maximize efficiency thereof

The general operating principles of hydraulic system 60 shown in FIG. 3 are similar to those of hydraulic system 10 shown in FIG. 1, with the primary difference being the utilization of an internal bypass port 78 within hydraulic transformer 62 to control the pressure supplied to the inlet of hydraulic motor 64.

Other aspects, objects and advantages of this invention can be obtained from a study of the drawings, the disclosure and the appended claims.

Other aspects, objects and advantages of this invention can be obtained from a study of the drawings, the disclosure and the appended claims.

What is claimed is:

1. A hydraulic system, comprising:
a hydraulic pressure source;
a hydraulic transformer having an inlet and an outlet, said inlet coupled with said pressure source;
at least one hydraulic motor; and
a bypass valve operatively coupling at least one said motor selectively either with said pressure source or said hydraulic transformer outlet, dependent upon an operating characteristic associated with at least one said hydraulic motor.

2. The hydraulic system of claim 1, including a hydraulic load coupled with at least one said hydraulic motor, said bypass valve fluidly coupling at least one said motor selectively either with said pressure source or said hydraulic transformer outlet, dependent upon an operating characteristic associated with said hydraulic load.

3. The hydraulic system of claim 1, at least one said motor including an output shaft, said operating characteristic being one of an output speed and output torque associated with said output shaft.

4. The hydraulic system of claim 1, said bypass valve fluidly coupling said hydraulic transformer inlet with said hydraulic transformer outlet.

5. The hydraulic system of claim 1, said bypass valve being a normally open valve.

6. The hydraulic system of claim 5, said bypass valve being one of separate from and integral with said hydraulic transformer.

7. The hydraulic system of claim 6, said hydraulic transformer including a bypass port, said bypass valve including said bypass port.

8. A work machine, comprising:
a frame; and
a hydraulic system including:
a hydraulic pressure source;
a hydraulic transformer having an inlet and an outlet, said inlet coupled with said pressure source;
at least one hydraulic motor; and
a bypass valve operatively coupling at least one said motor selectively either with said pressure source or said hydraulic transformer outlet, dependent upon an operating characteristic associated with at least one said hydraulic motor.

9. A hydraulic system, comprising:
a hydraulic pressure source;
a hydraulic transformer having an inlet and an outlet, said inlet coupled with said pressure source; and
a plurality of hydraulic motors, each said hydraulic motor being fluidly coupled in a parallel manner with at least one of said hydraulic transformer outlet and said pressure source, at least two of said hydraulic motors being configured with different operating ranges.

10. The hydraulic system of claim 9, including a bypass valve fluidly coupling at least one said motor selectively either with said pressure source or said hydraulic transformer outlet, dependent upon an operating characteristic associated with at least one said hydraulic motor.

11. The hydraulic system of claim 9, one of said plurality of motors being directly coupled with said pressure source and an other of said plurality of motors being directly coupled with a corresponding said hydraulic transformer.

12. The hydraulic system of claim 11, said one motor being configured with a higher efficiency operating range when operating at a higher speed and lower torque, when compared with said other motor.

13. A work machine, comprising:
a frame; and
a hydraulic system including:
a hydraulic pressure source;
a hydraulic transformer having an inlet and an outlet, said inlet coupled with said pressure source; and
a plurality of hydraulic motors, each said hydraulic motor being fluidly coupled in a parallel manner with at least one of said hydraulic transformer outlet and said pressure source, at least two of said hydraulic motors being configured with different operating ranges.
